(19) United States
(12) Patent Application Publication
(10) Pub. No.: US 2003/0081279 A1
(43) Pub. Date: May 1, 2003

(54) Optical interface

(75) Inventor: Yoshitaka Uchino, Tokyo (JP)

Correspondence Address: FOLEY AND LARDNER, SUITE 500, 3000 K STREET NW, WASHINGTON, DC, 20007, US

(73) Assignee: NEC Engineering, Ltd

(21) Appl. No.: 10/279,832

(22) Filed: Oct. 25, 2002

(30) Foreign Application Priority Data
Oct. 29, 2001 (JP) 2001-331078

(51) Int. Cl. H04B 10/08

(52) U.S. Cl. 359/110

(57) ABSTRACT

Provided is an optical interface which can continuously perform data transmission even in the case where an optical fiber cable breaks down, and can achieve a highly reliable transmission system. The optical interface is for converting full duplex high-speed serial electric signals and the like complied with an IEEE1394.b to optical signals. The optical interface comprises: a double transmission line made up of a main transmission line and a spare transmission line; an malfunction detection unit for detecting a transmission malfunction occurring in the main transmission line; and a switching unit for switching the transmission line from the main transmission line to the spare transmission line when the malfunction detection unit detects a transmission malfunction in the main transmission line. The malfunction detection unit monitors, periodically, the state of signal detection signals transmitted from photoelectric conversion units provided in each of the main transmission line and the spare transmission line.

### BACKGROUND OF THE INVENTION

1. Field of the Invention

The invention relates to an optical interface, and in particular, to an optical interface used when performing long distance transmission and the like complied with an IEEE1394.b.

2. Description of the Related Art

An optical fiber cable has a structure in which light is reflected inside a cable using a material such as glass. Therefore, it is easier to be broken by an external pressure such as being bent compared to an ordinal metal cable. However, in order to perform long distance transmission and the like complied with an IEEE1394. b, the optical fiber used at present is essential as a cable with less deterioration in signal levels.

On the other hand, a noncontact information transmission device disclosed in Japanese Patent Application Laid-open Hei 11-338587 is configured to perform a noncontact transmission between a light-emitting device and a light-receiving device facing each other with a space gap therebetween by receiving serial signals as signals for optical fiber transmission from serial signals of USB or IEEE1394. It is provided in consideration that the connection of a connector between an information device such as a computer and a docking unit for extending function is likely to be incomplete and transmission errors are to be easily occurred.

As described, when long distance transmission or the like complied with an IEEE1394. b is performed using an optical fiber cable, the optical fiber cable is prone to be easily broken down. Therefore, it causes a problem that communication is to be shut down in the case where the optical fiber cable breaks down.

On the other hand, with the noncontact information transmission device disclosed in Japanese Patent Application Laid-open Hei 11-338587, although transmission errors can be decreased between the information device and the docking unit for extending function, the problem regarding breakdown of the optical fiber cable cannot be solved since it only provides full duplex communication in the optical communication unit.

### SUMMARY OF THE INVENTION

The present invention has been designed to overcome the foregoing problems. An object of the present invention is to provide an optical interface which can continue data transmission even if an optical fiber cable breaks down and can achieve a highly reliable transmission system. Another object of the invention is, in addition to this, to provide an optical interface which enables data transmission with low electric power.

In order to achieve the foregoing objects, the present invention provides an optical interface for converting full duplex serial electric signals to optical signals. The optical interface comprises: a double transmission line made up of a main transmission line and a spare transmission line; an malfunction detection unit for detecting a transmission malfunction occurring in the main transmission line; and a switching unit for switching the transmission line from the main transmission line to the spare transmission line when the malfunction detection unit detects a transmission malfunction occurring in the main transmission line.

According to the invention, the transmission line is switched to the spare transmission line by the switching unit when a transmission malfunction occurring in the main transmission line is detected by the malfunction detection unit so that data transmission can be continuously performed. Thus, data transmission can be continuously performed even in the case where the optical fiber cable breaks down or the like. Thereby, a highly reliable transmission system can be achieved. Also, by providing ON/OFF electric supply to a photoelectric conversion unit as well as switching the transmission line by the switching unit, data transmission can be achieved with low electric power.

As a preferable example of the optical interface according to the invention, the malfunction detection unit monitors, periodically, the state of signal detection signals transmitted from a photoelectric conversion unit provided in each of the main transmission line and the spare transmission line.

In the optical interface according to the invention, the serial electric signals are full duplex high-speed electric signals complied with an IEEE1394. b. Thereby, it becomes possible to provide an optical interface which can achieve a highly reliable transmission system complied with an IEEE1394. b.

In the optical interface of the invention, the switching unit is a discrete circuit for switching the connection between a physical layer device and either the main transmission line or the spare transmission line upon receiving a switching signal from the malfunction detection unit.

In the invention, a discrete circuit is used. Therefore, it is possible to provide an optical interface which requires a little space and a low manufacturing cost.

In the optical interface according to the invention, each of the main transmission line and the spare transmission line is equipped with a respective physical layer device.

In the invention, two physical layer devices are used. Therefore, switching by the discrete circuit becomes unnecessary so that the switching control becomes more flexible.

### BRIEF DESCRIPTION OF THE DRAWINGS

FIG. 1 is a schematic block diagram showing an embodiment of an optical interface according to the present invention;

FIG. 2 is a detailed block diagram of the optical interface shown in FIG. 1;

FIG. 3 is a switching control timing chart for describing duplex switching timing of the optical interface shown in FIG. 1;

FIG. 4 is an illustration showing transition of the switching control state of the optical interface shown in FIG. 1; and

FIG. 5 is a schematic block diagram showing another embodiment of the optical interface according to the present invention.

### DETAILED DESCRIPTION OF THE PREFERRED EMBODIMENTS

Now, a specific example of an embodiment of an optical interface according to the present invention will be described by referring to the accompanying drawings.

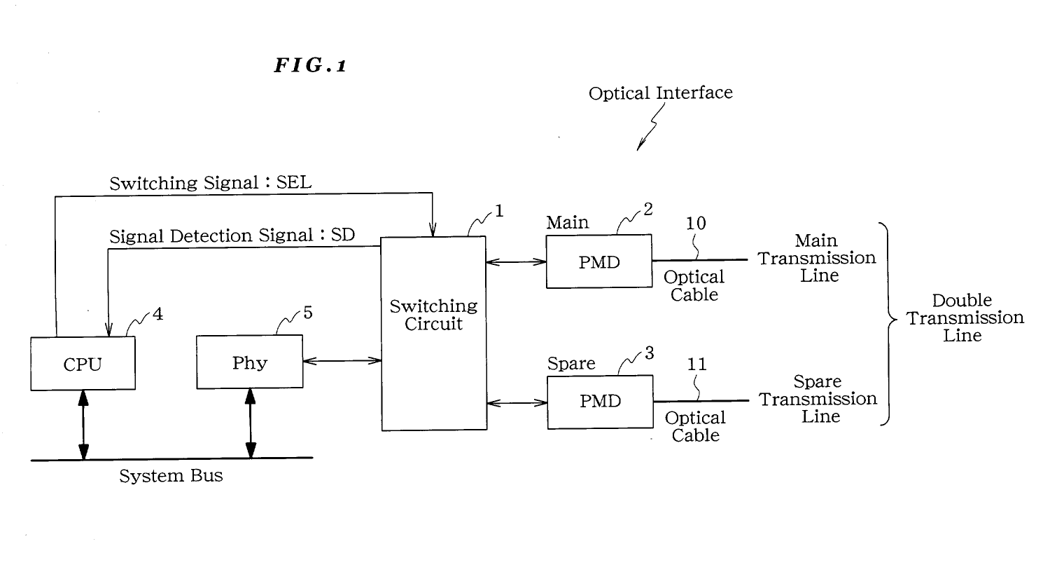

FIG. 1 shows a schematic structure of an optical interface of the present invention complied with an IEEE1394.b. In the optical interface, photoelectric conversion devices (PMD) 2 and 3 are devices for converting electric signals to light. The devices convert full duplex high-speed serial electric signals complied with an IEEE1394.b to optical signals, and achieve data transmission via optical fibers.

A Switching Circuit 1 comprises a discrete circuit and has a function of switching a full duplex serial signals and a signal detection signal SD showing existence of an optical carrier. Further, a CPU 4 monitors the state of signal detection signals SD outputted from the PMDs 2 and 3, judges the malfunction of optical cables 10 and 11 by time base and then outputs a switching signal to the switching circuit 1. A Phy device 5 is a physical layer device for performing transmission and reception of signals complied with an IEEE1394.a and IEEE1394.b.

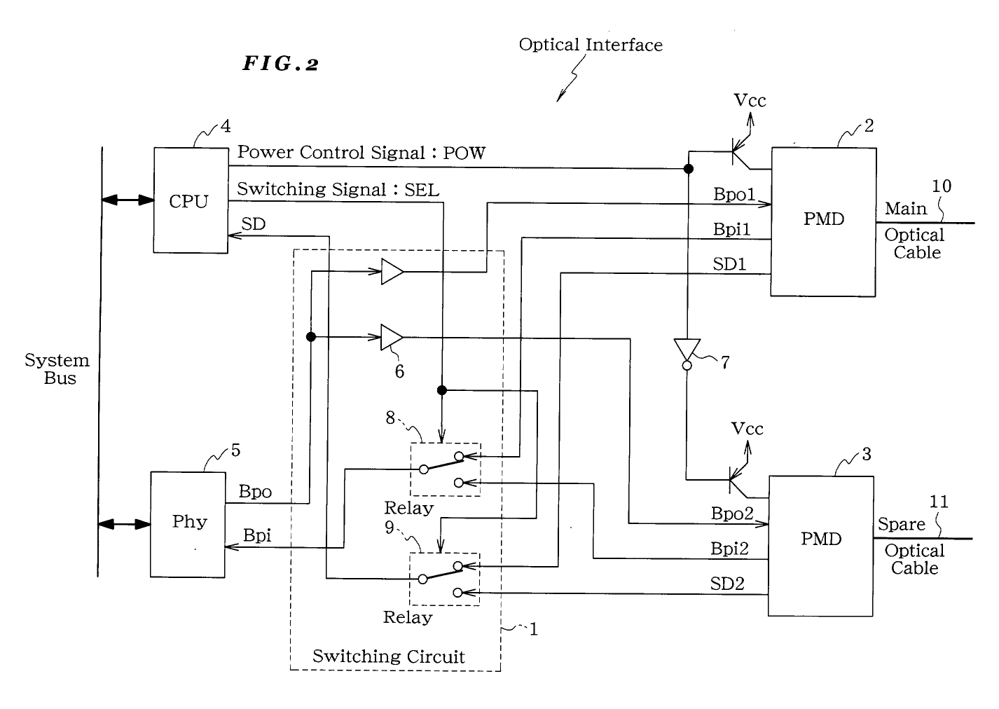

FIG. 2 is a detailed block diagram obtained by adding signal line levels to the schematic block diagram shown in FIG. 1, and shows a detailed structure and the like of the Switching Circuit 1.

A transmission signal Bpo is outputted from the Phy device 5 and is separated in a buffer 6. Then, the separated signals are transmitted as Bpo1 and Bpo2, respectively, to a main PMD 2 and a spare PMD 3 and are converted to optical signals by the PMDs 2 and 3 thereby transmitted to a receiver side device.

A relay 8 switches the photoelectrically-converted serial electric signals Bpi 1 from the main PMD 2 and Bpi 2 from the spare PMD 3 to signals from an activated PMD (2 or 3). Also, a relay 9 transmits the signal detection signal SD (SD1 or SD2) from the main PMD 2 and the spare PMD 3 to the CPU 4.

In the above-described two relays 8 and 9, the CPU 4 monitors the signal detection signal SD at given period of time and judges whether or not the state is malfunction. When it is judged that the state is malfunction based on the SD signal, the CPU 4 switches the relay 9 by the switching signal SEL. The switching signal SEL outputted from the CPU 4 is also used as a signal for controlling ON/OFF of the power source Vcc of two PMDs 2 and 3.

The detailed structure of the embodiment has been described heretofore. However, the detailed description of structures of the CPU 4 and the Phy device 5 will be omitted since they are well known to those skilled in the art and are not directly relative to the present invention.

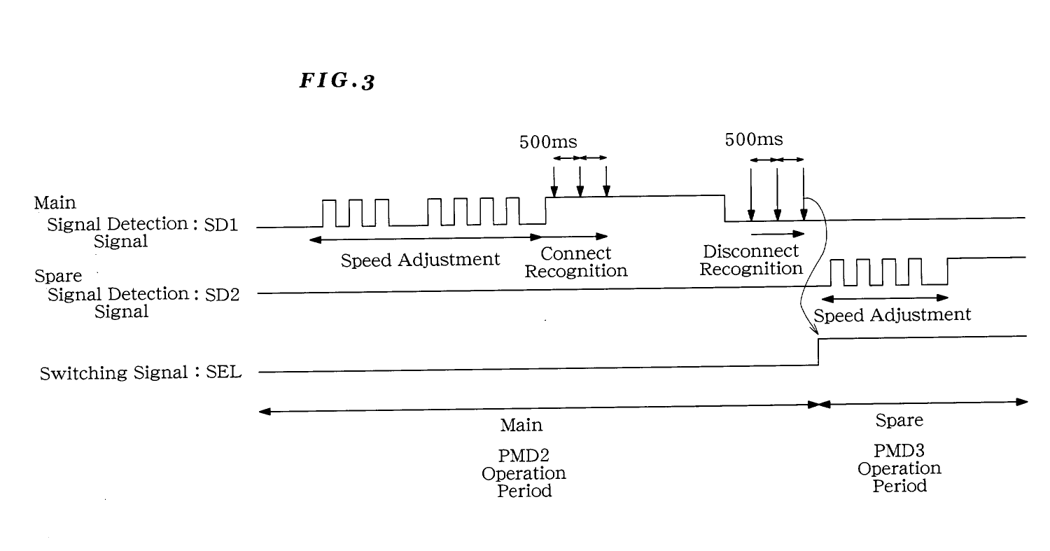

Next, the PMD switching operation of the optical interface with the above-described structure will be described by referring to the switching control timing chart shown in FIG. 3. The description will be made based on the signal detection signal SD1 outputted from the main PMD 2 and the signal detection signal SD2 outputted from the spare PMD 3.

In the normal operation state, first, long distance transmission is performed by achieving photoelectric conversion through the main PMD 2 shown in FIG. 2. At this time, the SD1, as shown in FIG. 3, intermittently outputs toning pulse for speed adjustment and maintains High state when the speed adjustment is completed. The CPU 4 monitors the period where the High state is stable by every 500 ms. If the High state is recognized for three consecutive times, the CPU 4 judges that connection is normally achieved.

The SD1 signal has such a characteristic that it becomes Low in a malfunction state. Thus, as for the switching process of the case where there is malfunction occurring in the cables and the like, the CPU 4 monitors the period of Low and judges that it is malfunction when the Low is recognized for three consecutive times, and switches the switching signal SEL shown in FIG. 3 to High and connect it to the spare PMD 3 shown in FIG. 2. After the switching, the spare PMD 3 performs the speed adjustment as in the same manner as that in the main PMD 2. After completing the adjustment, in the period where the High state is stable, the state of the SD2 signal is monitored by every 500 ms as in the same manner as the connection verification processing of the main PMD 2 so as to judge whether or not the connection is achieved. Then, communication processing is moved on to be carried out thereafter. The switching signal SEL is the same as the switching signal outputted from the CPU 4 shown in FIG. 2.

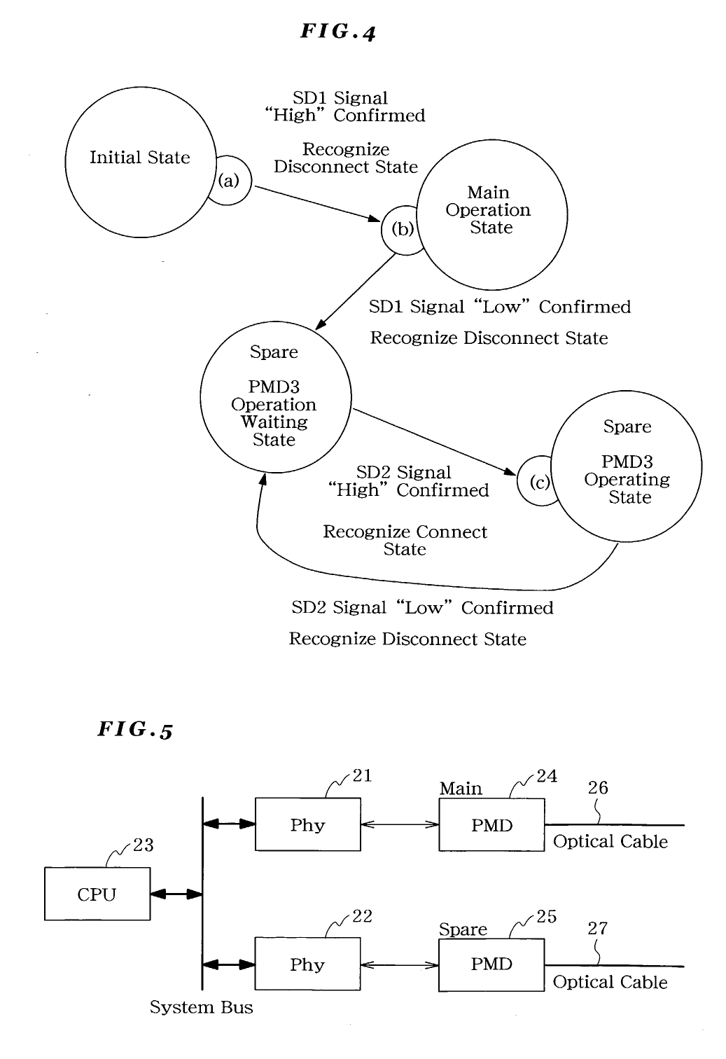

Furthermore, the specific operation will be described in time sequence using the state transition chart shown in FIG. 4. The state transition chart shows a processing performed inside the CPU 4 shown in FIG. 2.

In FIG. 4, the state after the power source is supplied to the device is to be the initial state. The state of the signal detection signal SD1 of the main PMD 2 shown in FIG. 2 is monitored in (a) section at the initial state. First, after recognizing the SD1 signal to be High, the state moves on to the operation state of the main PMD 2 and the signal detection signal SD1 are monitored in (b) section by every 500 ms. If High state is recognized for three consecutive times, data transmission processing for starting the operation in the main PMD 2 is started. When performing data transmission, (b) section continuously monitors the state of the signal detection signals SD1 by every 500 ms. When Low is recognized for three consecutive times, it is judged that the main PMD 2 is malfunction and a power source control signal POW is switched to High so as to OFF the main PMD 2 shown in FIG. 4.

After the switching, the state moves on to the spare PMD operation waiting state shown in FIG. 4 after waiting for 100 ms until the power source of the spare PMD 3 shown in FIG. 2 becomes stable. In the waiting state, first, in order to activate the connection to the spare PMD 3, the switching signal SEL shown in FIG. 2 is switched from Low to High. After waiting for 200 ms, High of the signal detection signal SD2 of the spare PMD 3 is verified and then the state moves on to (c) section. In the (c) section, in order to check whether or not the spare PMD 3 is connected, the signal detection signal SD2 switched to the spare PMD 3 is monitored by every 500 ms as in the same manner as the main PMD 2. When the High state is recognized for three consecutive times or more, it is judged that the spare optical cable is connected and data transmission is normally achieved. Thus, the state moves on to the spare PMD 3 operation state shown in FIG. 4. In the spare PMD operation state, the spare signal detection signal SD2 is monitored by every 500 ms. When Low is detected for three consecutive times or more, it is judged that the spare PMD 3 is malfunction and starts an operation of moving on to the spare PMD 3 operation waiting state shown in FIG. 4.

By alternately detecting the signal detection signal outputted from the two PMDs 2 and 3, data transmission can be continued through switching from the main to spare PMD 3 in the case where the main PMD 2 becomes malfunction. As a result, transmission lines of IEEE1394 can be doubled. Therefore, highly reliable transmission can be achieved and convenience for users can be improved.

FIG. 5 shows another embodiment of the present invention. The basic structure of the optical interface according to the embodiment is the same as the one described above. However, the switching method of the optical interface is further devised. In other words, as shown in FIG. 5, by directly connecting the interface of IEEE1394. b to the Phy devices 21 and 22 as the physical layer devices respectively provided in the main and spare PMDs, it becomes possible for a CPU 23 to perform more flexible switching control of the optical interface via a system bus. As described, in the embodiment, a separate transmission line is provided for a main PMD 24 and a spare PMD 25 so that it becomes unnecessary to provide a Switching Circuit with a discrete circuit.

In the structure as described, it is also possible to have a structure with a Phy device with one physical layer and two or more optical interfaces of IEEE1394. b.

As described, with the present invention, data transmission can be continuously performed even when the optical fiber cable breaks down. Therefore, it is possible to provide an optical interface capable of achieving a highly reliable transmission system and the like.

The invention may be embodied in other specific forms without departing from the spirit or essential characteristic thereof. The present embodiments are therefore to be considered in all respects as illustrative and not restrictive, the scope of the invention being indicated by the appended claims rather than by the foregoing description and all changes which come within the meaning and rage of equivalency of the claims are therefore intended to be embraced therein.

The entire disclosure of Japanese Patent Application No. 2001-331078 (Filed on Oct. 29, 2001) including specification, claims, drawings and summary are incorporated herein by reference in its entirety.

What is claimed is:

1. An optical interface for converting full duplex serial electric signals to optical signals, comprising:
a double transmission line including a main transmission line and a spare transmission line;
an malfunction detection unit for detecting a transmission malfunction occurring in the main transmission line; and
a switching unit for switching the transmission line from the main transmission line to the spare transmission line when the malfunction detection unit detects a transmission malfunction occurring in the main transmission line.

2. The optical interface as claimed in claim 1, wherein the malfunction detection unit monitors, periodically, the state of signal detection signals transmitted from a photoelectric conversion unit provided in each of the main transmission line and the spare transmission line.

3. The optical interface as claimed in claim 1, wherein the serial electric signals are full duplex high-speed electric signals complied with an IEEE1394. b.

4. The optical interface as claimed in claim 2, wherein the serial electric signals are full duplex high-speed electric signals complied with an IEEE1394. b.

5. The optical interface as claimed in claim 3, wherein the switching unit is a discrete circuit for switching the connection between a physical layer device and either the main transmission line or the spare transmission line upon receiving a switching signal from the malfunction detection unit.

6. The optical interface as claimed in claim 4, wherein the switching unit is a discrete circuit for switching the connection between a physical layer device and either the main transmission line or the spare transmission line upon receiving a switching signal from the malfunction detection unit.

7. The optical interface as claimed in claim 3, wherein each of the main transmission line and the spare transmission line is equipped with a respective physical layer device.

8. The optical interface as claimed in claim 4, wherein each of the main transmission line and the spare transmission line is equipped with a respective physical layer device.
